(19) United States
(12) Patent Application Publication
(10) Pub. No.: US 2016/0223855 A1
(43) Pub. Date: Aug. 4, 2016

(54) LIQUID-CRYSTAL DISPLAY DEVICE AND A MANUFACTURING METHOD OF IT

(71) Applicant: Japan Display Inc., Minato-ku (JP)

(72) Inventor: Junichi KOBAYASHI, Minato-ku (JP)

(73) Assignee: Japan Display Inc., Minato-ku (JP)

(21) Appl. No.: 15/010,367

(22) Filed: Jan. 29, 2016

(30) Foreign Application Priority Data
Feb. 3, 2015 (JP) 2015-019222

(51) Int. Cl. G02F 1/1335; G02F 1/1339; G02F 1/1362; G02F 1/1368; G02F 1/1343

(52) U.S. Cl. CPC G02F 1/133512; G02F 1/1368; G02F 1/134309; G02F 1/136286; G02F 1/13394

(57) ABSTRACT

An LCD device according to a group of embodiments comprises: an array substrate, on which signal and scanning lines and pixel electrodes are arrayed and a resin film is provided; a counter substrate; a liquid-crystal layer interposed between the array and counter substrates; and rib-shaped protrusions, which are arranged on the array substrate within a viewing area so as to respectively run along the signal lines and to respectively cover the signal lines, and which are formed by a resin layer of first resin film as integral with the first resin film, and top parts of the rib-shaped protrusions being distanced from inner face of the counter substrate.

### CROSS-REFERENCE TO RELATED APPLICATIONS

This application is based upon and claims the benefit of priority from the prior Japanese Patent Application No. 2015-019222, filed on Feb. 3, 2015; the entire contents of which are incorporated herein by reference.

### FIELD

Embodiments of the present invention relate to a liquid-crystal display (LCD) device displaying images, and particularly relate to an LCD device, in which lateral-electric field including fringe-electric field is applied to a liquid crystal layer at a time of driving the device and a manufacturing method of it.

### BACKGROUND

The LCD devices are most typical among flat-panel display (FPD) devices and are widely used as display devices for PCs and TV sets, for computer terminals, for vehicle-mounted display devices such as car navigators and rear-view monitors, and for mobile devices such as smart phones and other mobile phones as well as information terminals or digital assists. The display panel of the liquid-crystal display (LCD) device comprises an array substrate and a counter substrate, which are adhered to each other through a sealing material, and a liquid crystal layer interposed between these substrates. The array substrate generally has: on a viewing area, in which pixels are arrayed, scanning lines and signal lines that are arranged in a lattice; and switching elements and pixel electrodes, each of which is arranged in vicinity of respective intersection of the scanning and signal lines.

When the viewing area of the LCD device is obliquely observed, or when observation angle is very large, it occasionally happens that, along a fringe of a pixel dot or a single-color subpixel, light leakage from adjacent pixel dot appears to be mixed in. For example, along a fringe of red pixel dot, it might occur “color mixing”, by which a green light leaked from adjacent green pixel dot is mixed into red color light.

In particular, recently widely used are: the LCD devices of lateral-electric field mode, which is often referred to as In-Plane Switching (IPS) mode. In the lateral-electric field mode LCD devices, common electrodes or counter electrodes are arranged in the array substrates; electric fields, which are mainly in directions along the array substrates, are applied to the liquid-crystal layers so that levels of light transmittance through the liquid-crystal layers are controlled; and in this way, images are displayed with high resolutions and, in same time, with almost no dependency to observation angle. In Fringe Field Switching (FFS) mode LCD devices in particular among the lateral-electric field mode LCD devices, the pixel electrodes are arranged as overlapped with the common electrodes, with an insulator layer interposed between layers of the pixel and common electrodes, so that the fringe-electric fields are applied to the liquid crystal layers to control their light transmittance. The FFS mode LCD devices are advantageous in that energy consumption efficiency is able to be enhanced, and hence are widely used in the mobile devices. In the lateral-electric field mode LCD devices, electric field shielding between adjacent pixel dots would not be perfect and, hence, the “color mixing” would tend to occur in particular.

To cope with such problems, JP2014-006427A proposes that: color filter layers are arranged on the array substrate; and by a pattern formed subsequent to the color filter layer, wall structures (“1st wall structures WL1”) are respectively formed along signal lines (“signal wirings DL”). Please see FIGS. 1-2 in particular. Projections of the wall structures protrude through the liquid crystal layer up to the counter substrate; and have a layer of the pixel electrodes (“source electrodes SE”) on almost vertically extending wall faces. By such “on-wall electrodes IPS-LCD”, it is asserted that “nearer-to-parallel electric field is applicable to the liquid-crystal layer” ([0004]). Meanwhile, JP2014-021267A proposes that: at along borders of the pixel dots, thickness of common electrodes (“common electrodes 1101”) is increased to 5 times to 30 times of other parts of the common electrodes.

Meanwhile, JP2013-186148A shows an LCD device, in which column spacers are formed by “spacer portions 4”, which are protruded from the array substrate 1, and “spacer portions 5” that are protruded from the counter substrate 2 as the “spacer portions 4” abut respectively on the “spacer portions 5” in vertical direction. In particular, the “spacer portions 4” on the array substrate run in a direction of the scanning lines while the “spacer portions 5” on the counter substrate run in a direction of the signal lines so that the spacer portions would not scratch the substrates within the viewing area.

### BRIEF DESCRIPTION OF THE DRAWINGS

FIG. 1 is a thickness-direction sectional view taken in a direction along scanning lines, showing an essential part of an embodiment of the LCD device, in which a rib-shaped protrusion and pixel-dot apertures appear, as a cross section along I-I line in FIGS. 4-5;

FIG. 2 is a thickness-direction sectional view taken in a direction along scanning lines, showing apart of the LCD device of FIG. 1, in which a counter protrusion appears, as a cross section along II-II line in FIGS. 4-5;

FIG. 3 is a thickness-direction sectional view taken in a direction along signal lines, showing a part of the LCD device of FIG. 1, as a cross section along line in FIG. 4;

FIG. 4 is a plan view showing an example of overall construction of the pixel dot on an array substrate in the LCD device of FIG. 1;

FIG. 5 is a plan view corresponding to FIG. 4, indicating the rib-shaped protrusion on the array substrate and the counter protrusion on the counter substrate;

FIG. 6 is a thickness-direction sectional view corresponding to FIG. 1, showing a comparative example of an LCD device in a prior-art construction;

FIG. 7 is a graph showing distributions of light modulation ratios, in the LCD device of FIG. 1 as the embodiment and in the LCD device of FIG. 6 as the comparative example; and

FIG. 8 is a thickness-direction sectional view corresponding to FIG. 1, showing a modified embodiment of an LCD device.

### DETAILED DESCRIPTION

1. An LCD device according to preferred embodiments comprises: an array substrate, on which signal and scanning lines and pixel electrodes are arrayed and a resin film is provided; a counter substrate; a liquid-crystal layer interposed between the array and counter substrates; and rib-shaped protrusions, which are arranged on the array substrate within a viewing area so as to respectively run along the signal lines and to respectively cover the signal lines, and which are formed by a resin layer of first resin film as integral with the first resin film, and top parts of the rib-shaped protrusions being distanced from inner face of the counter substrate. By such embodiments, even when observation angle is large, it is prevented or decreased to induce display defect at along a fringe of a pixel dot, into which a light leaked from adjacent pixel dot is mixed. In the embodiments, counter substrate is formed by using a transparent substrate such as a glass plate; and the array substrate is preferably formed by using a transparent substrate such as a glass plate.

2. In preferred embodiments, in the device according to clause 1, the first resin film covers at least the signal lines and switching elements.

3. An LCD device according to preferred embodiments comprises first and second substrates and a liquid-crystal layer interposed between the substrates; the first substrate comprising: first transparent substrate; signal lines that are arrayed with an interval in a first direction; scanning lines that are arrayed with an interval in a second direction that intersects the first direction; switching elements, each of which is electrically connected with one of the scanning lines and with one of the signal lines; and a first resin film that at least covers the switching elements and the signal lines; the second substrate comprising second transparent substrate; wherein a first gap (D1-D2), which is a distance between the first resin film and the second transparent substrate at regions overlapped with the signal lines, is smaller than a second gap (D1) that is a distance between the first resin film and the second transparent substrate at regions overlapped with the pixel electrodes.

4. In preferred embodiments, in the device according to any one of clauses 1-3, the rib-shaped protrusions, which respectively run along the signal lines and respectively cover the signal lines, are abutted on counter protrusions arranged on the counter substrate so as to form spacers between the substrates. Preferably, the counter protrusions are elongated in a direction intersecting the signal lines and the rib-shaped protrusions.

5. In preferred embodiments, in the device according to clause 4, the counter protrusions are formed by second resin film that is arranged on the counter substrate or the second substrate. In preferred embodiments, the second resin film covers substantially whole of the viewing area of the counter substrate or the second substrate.

6. In preferred embodiments, in the device according to clause 4 or 5, the counter protrusions are arranged in a light-shielded area within the viewing area and are elongated in a direction along the scanning lines.

7. In preferred embodiments, in the device according to any one of clauses 1-6, a ratio of protrusion height of the rib-shaped protrusions covering the signal lines, with respect to thickness of the liquid-crystal layer at regions of the pixel electrodes on flat areas within pixel-dot apertures, is in a range of 15% to 70%, preferably in a range of 25% to 55%, more preferably in a range of 30% to 50%.

8. In preferred embodiments, in the device according to any one of clauses 1-7, a ratio of the first gap or a distance between top of the rib-shaped projection and inner face of the counter substrate, with respect to the second gap or a distance between the substrates or thickness of the liquid-crystal layer at regions of the pixel electrodes on flat areas within pixel-dot apertures, is in a range of 30% to 85%, preferably in a range of 45% to 75%, more preferably in a range of 50% to 70%.

9. In preferred embodiments, in the device according to anyone of clauses 1-8, a ratio of width of each of the rib-shaped protrusions at a half height of their protrusion height, with respect to a width of respective line part of the black matrix, is in a range of 0.8 to 1.3, more preferably in a range of 0.9 to 1.2. Preferably, a ratio of width of each of the rib-shaped protrusions at a half height of their protrusion height, with respect to a width of the signal line, is in a range of 1.5 to 4, more preferably in a range of 2 to 3.

10. In preferred embodiments, in the device according to any one of clauses 1-9, common electrodes are arranged in the array substrate or the first substrate, to be nearer to inner surface of the substrate than the first resin film, by which the rib-shaped protrusions are formed.

11. In preferred embodiments, in the device according to clause 10, the common electrodes cover the flat areas in the pixel-dot apertures, or regions forming the second gap (D1), in a construction of FFS mode LCD device; and the common electrodes also cover the rib-shaped protrusions at regions sandwiching the flat areas in the pixel-dot apertures.

12. In preferred embodiments, in the device according to any one of clauses 1-11, the rib-shaped protrusions covering the signal lines or regions forming the first gap are arranged along the signal lines, at least throughout their regions sandwiching the flat area of each of the pixel-dot apertures.

13. In preferred embodiments, in the device according to any one of clauses 1-12, the rib-shaped protrusions are, in a cross section, outlined as a circular or oval arc or a parabola, or a trapezoid having rounded angles.

14. In preferred embodiments, in the device according to any one of clauses 1-13, thickness of the first resin film is in a range of 0.5 μm to 2 μm.

15. In preferred embodiments, in the device according to any one of clauses 1-14, the second gap or a distance between the substrates, or thickness of the liquid-crystal layer, at regions of the pixel electrodes on the flat area within pixel-dot apertures is in a range of 2 μm to 5 μm, preferably in a range of 2 μm to 3 μm.

16. In preferred embodiments, in the device according to any one of clauses 1-15, an end portion of each of pixel dots, which are elongated in a direction of the signal lines, is provided with a conduction area, through which the switching element and the pixel electrode is electrically connected; in respect of at least some of the pixel dots, the conduction area is sandwiched in a direction of the scanning lines by first and second regions; through the first region, the rib-shaped protrusion runs in a direction of the signal line; and at the second region, the rib-shaped protrusion is discontinued to form a distance larger than the first gap and smaller than the second gap. Preferably, aspect ratio or length-to-width ratio of each of the pixel dots is in a range of 2 to 8, more preferably in a range of 3 to 5.

17. In preferred embodiments, in the device according to clause 16, the rib-shaped protrusion at the first region is abutted on the counter protrusion on the array substrate or the second substrate to form a column spacer. Preferably, number ratio of the column spacers to the pixel dots is in a range of 2 to 8, more preferably in a range of 3 to 5.

18. In preferred embodiments, in the device according to any one of clauses 1-17, inner surface of the counter substrate or the second substrate, which contacts the liquid-crystal layer, is substantially flat within the viewing area except the protrusions for the column spacers.

19. In preferred embodiments, in manufacturing method for the device according to any one of clauses 1-18, the rib-shaped protrusions or resin layers forming the first gap are simultaneously formed with the resin film in remaining areas by a single resin-film forming process, which includes applying of light curable (including UV curable) resin on the array substrate of the first substrate as well as its half-tone exposure or by ink-jet technique.

### Embodiments

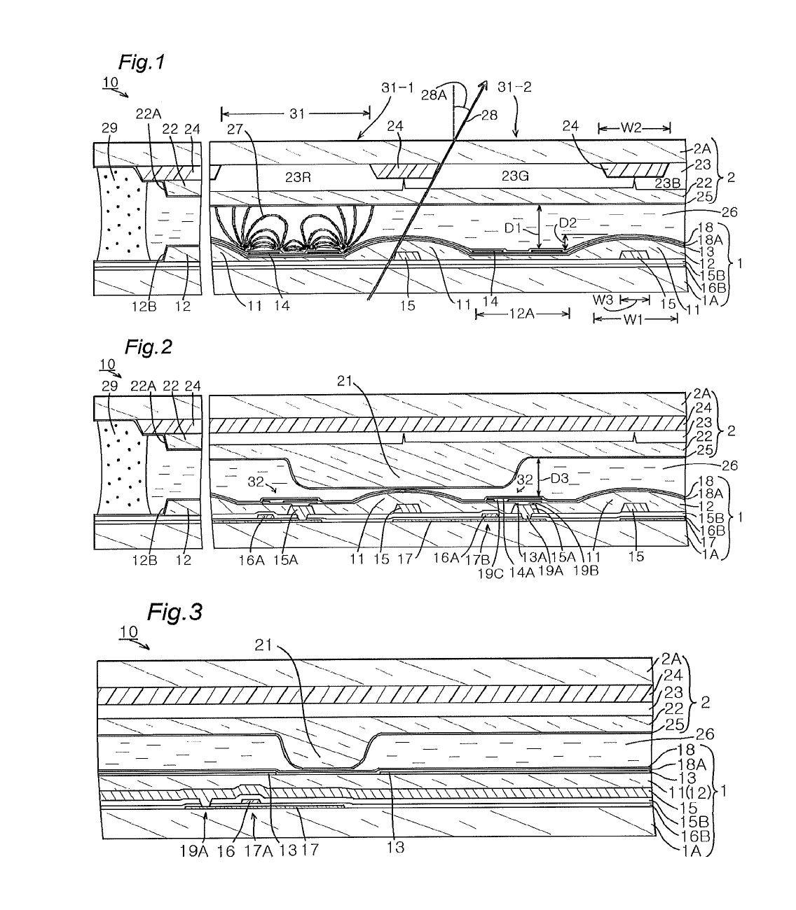

The LCD device of a detailed embodiment of the invention will be described with reference to FIGS. 1-5. In the detailed embodiment, the LCD device is of lateral-electric field mode, and of FFS mode in particular.

As shown in FIGS. 1-3, display panel 10 of the LCD device comprises: an array substrate 1; a counter substrate 2; a liquid-crystal layer 26 held in a gap between the substrates 1 and 2; and a sealing material 29 that bonds together peripheral portions of the substrates 1 and 2 and seals off the liquid-crystal layer 26 from outside.

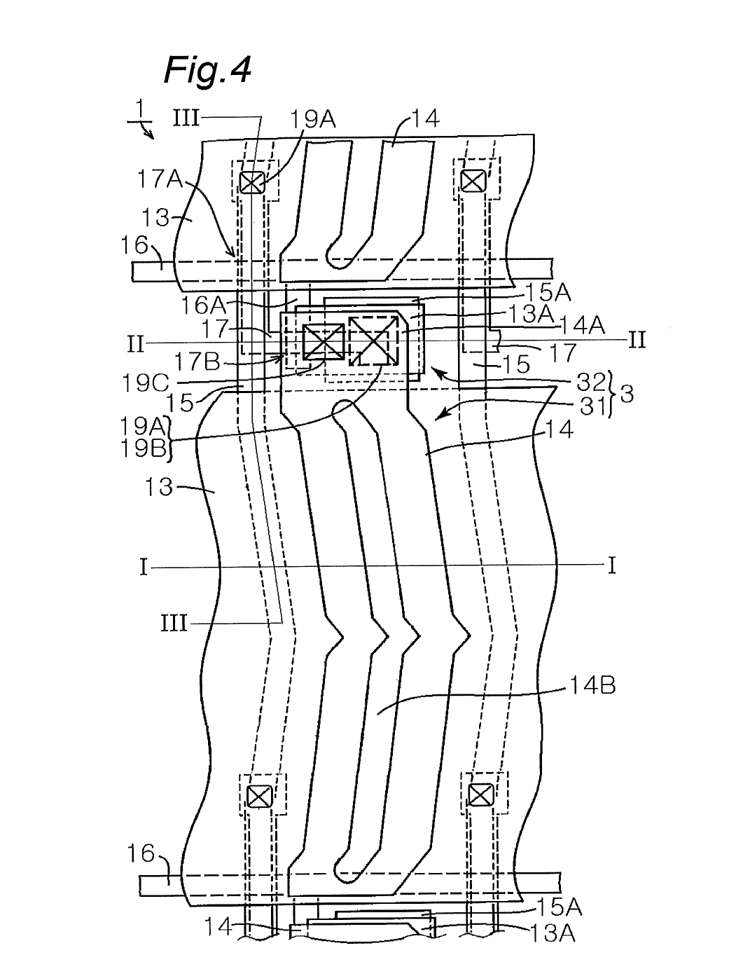

FIG. 4 shows a detailed example of overall construction of the pixel dot 3 on the array substrate 1. Signal and scanning lines 15 and 16, which are formed by light-shielding metal films, are arranged in a lattice; and corresponding to each intersection of the signal and scanning lines 15 and 16, there are arranged: TFTs (thin film transistors) 17A and 17B as switching elements; and a pixel dot 3 that has a pixel electrode 14 formed by transparent conductive material. The pixel electrode 14 and the pixel dot 3 are elongated in a direction along the signal lines 15. Most of a lengthwise region of each of the pixel dot 3 corresponds to the pixel-dot aperture 31, in which the pixel electrode 14 is arranged. In an end portion of the pixel-dot aperture 31, a switching-conductance area 32 is formed, in which an extended portion 14A is arranged as extended from the pixel electrode 14.

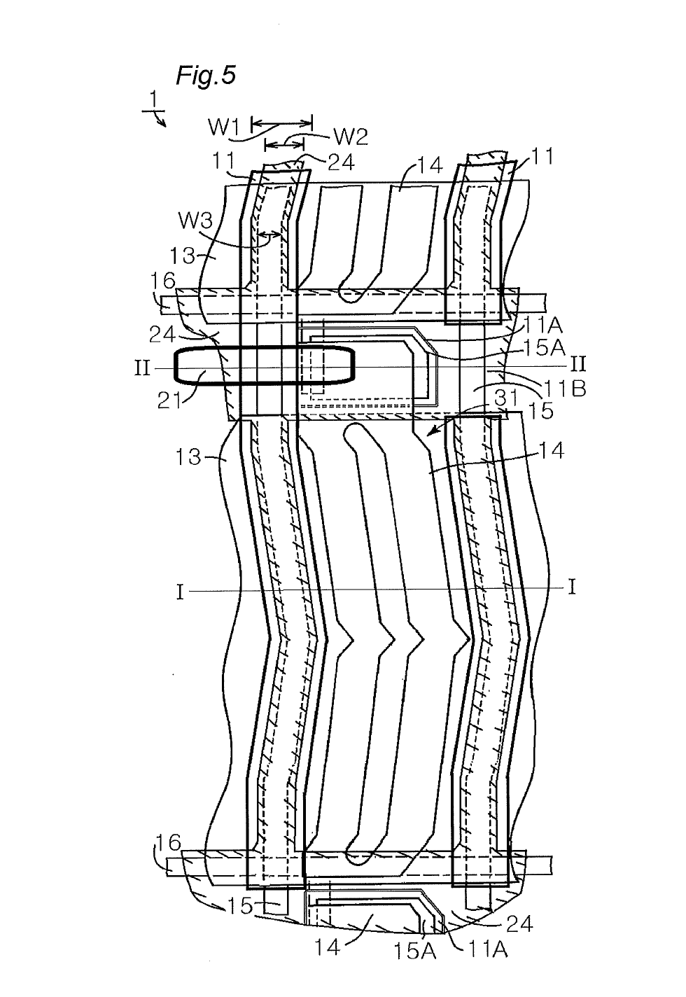

FIG. 5 shows main construction of the array substrate 2 as overlaid to that of FIG. 4. A black matrix 24, which is formed in a latticework on the counter substrate 2 by light-shielding film, comprises: first parts, each of which runs along, and covers up a vicinity, of one of the signal lines; and second parts, each of which covers up at least one of the switching-conductance areas 32, and its vicinity. In an illustrated embodiment, each of the second parts continuously runs along respective one of the scanning lines 16; and the latticework consists of the first parts and the second parts. Each opening of the black matrix 24 makes the pixel-dot aperture 31.

As shown in FIGS. 1-2 and 5, on the array substrate 1, each of the signal lines and its vicinity are covered by thick layer of resin film 12, by which a rib-shaped protrusion 11 is formed. In FIG. 5, each of the rib-shaped protrusions 11 is represented by its contour line that runs through points having half protrusion height relative to protrusion height D2, as presented in FIG. 1, of the rib-shaped protrusion 11. As shown in FIG. 5, in this embodiment, the rib-shaped protrusions 11 are continuously arranged throughout regions sandwiching in right-left or width direction, each of the pixel-dot apertures 31, which is elongated in a signal-line direction. In a detailed embodiment shown in FIG. 5, each of the switching-conductance areas 32 is sandwiched in the right-left direction by discontinued regions 11B, in which the rib-shaped protrusion 11 is omitted, except for regions forming the column spacers.

Meanwhile, within each of the pixel-dot apertures 31, the resin film 12 has relatively small thickness, except along fringes of the aperture 31, to form a flat area 12A in the aperture 31. In the illustrated embodiment, each of the pixel electrodes 14 is almost entirely arranged within the flat area 12A. Here, in this flat area 12A, the resin film 12 does not cover any conductive pattern; and thus, the resin film 12 may be omitted.

FIG. 1 is a schematic, thickness-direction sectional view in a direction along the scanning lines 16, i.e., a direction almost perpendicular to the signal lines 15, showing the pixel-dot apertures 31. As shown in FIG. 1, firstly, vicinity of each of the signal lines 15 is surely covered and electrically isolated by thick layer of the resin film 12 that forms the rib-shaped protrusions 11; and in same time, undesired parasitic capacitance between a conductive layer on the resin film 12 and each of the signal lines 15 is sufficiently minimized. Moreover, because each of the pixel electrodes 14 is arranged almost entirely within the flat area 12A, the liquid-crystal layer 26 may have a predetermined, uniform thickness D1 at along the pixel electrodes 14, which is larger than thickness at along the rib-shaped protrusions 11. In other words, thickness of the liquid-crystal layer 26 may become smaller at along the vicinity of each of the signal lines 15, which delimits the pixel-dot apertures 3, than the predetermined thickness D1 at along the pixel electrodes 14. In many occasions, with decreasing of the thickness of the liquid-crystal layer 26, light transmittance of the layer as modulated or controlled may be decreased; and in this way, the “color mixing” would be mitigated.

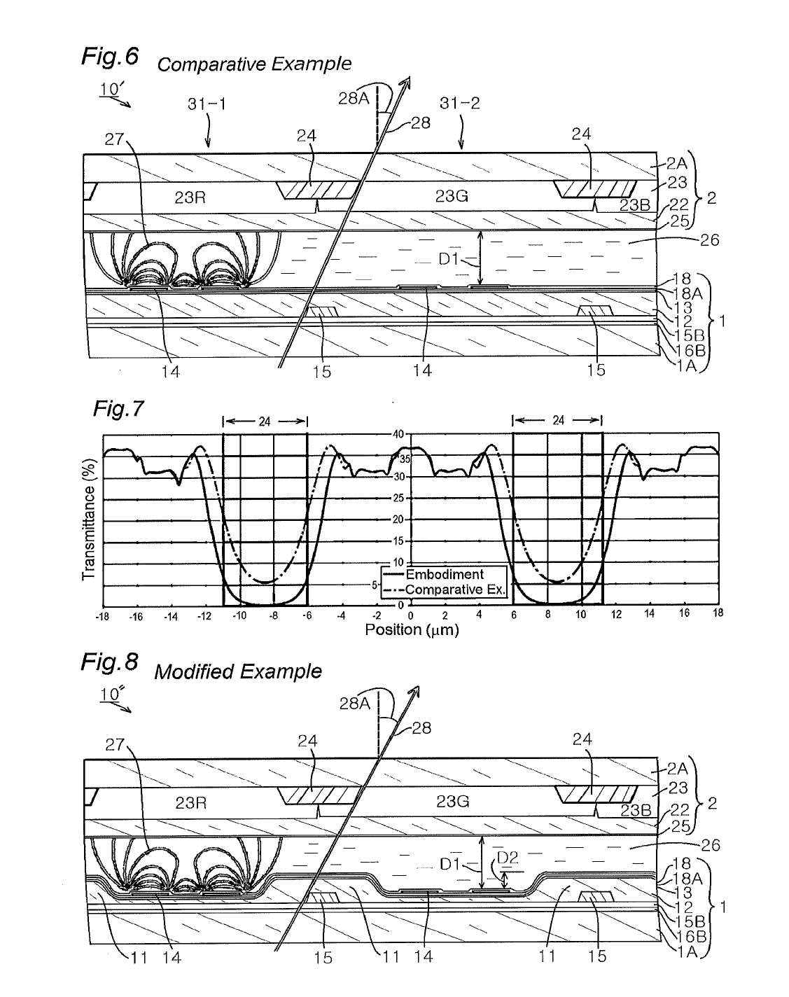

FIG. 6 is a thickness-direction sectional view corresponding to FIG. 1, showing a display panel 10′ of a comparative example of the LCD device. In the comparative example of FIG. 6, the resin film 12 is formed as a flattening film; and thus, a surface of the resin film 11 is flat and has uniform projection height from the glass substrate 1A of the array substrate 1. A resin film as a flattening film usually has a thickness in a range of 0.5 μm to 2 μm; thus, in this embodiment, maximum thickness of the resin film may be set in a range of 0.5 μm to 2 μm, and for example, preferably set in a range of 0.8 μm to 1.2 μm. Thickness of a metal layer that forms the signal lines 15 may be in a range of 0.1 μm to 0.3 μm. Thickness of transparent conductive layer that forms the pixel electrodes 14 and the common electrodes 13 is usually in a range of 10 nm to 30 nm or 0.01 μm to 0.03 μm.

As seen from comparison between the embodiment of FIG. 1 and the comparative example of FIG. 6, it is able to decrease a distance in a thickness or vertical direction from the signal lines 15 as a light-shielding layer on the array substrate 1 to the black matrix 24 on the counter substrate 2, by adopting the embodiment as compared to the comparative example. In detail, according to the embodiment of FIG. 1, the vertical distance between the signal lines 15 and the black matrix 24 may be decreased by protrusion height D2 of the rib-shaped protrusions 11 or by height difference between the flat area 12A and the protrusions 11, as compared to the comparative example.

In FIGS. 1 and 6, there is indicated an obliquely transmitted light 28 that passes through from one 31-1 of the pixel-dot apertures to adjacent one 31-2 of the pixel-dot apertures. There is also indicated a color-mixing critical angle 28A, which is a minimum possible angle for the obliquely transmitted light 28, with respect to the vertical direction. Different primary colors are allocated to adjacent pixel dots 3 delimited by the signal lines 15; and thus, the “color mixing” may occur at fringes of the pixel dots 3 by intermixing with light leaked from adjacent one of the pixel dots 3. As seen from the comparison between FIG. 1 and FIG. 6, the vertical distance from the signal lines 15 to the black matrix 24 is decreased so as to decrease the light-transmittance of the liquid-crystal layer, which is modulated or controlled, and increase the color-mixing critical angle 28A so that the color mixing is prevented or mitigated.

In following, it is explained further curbing of the color mixing by the rib-shaped protrusions 11, in an LCD device of lateral-electric field mode such as FFS mode.

In this embodiment, the common electrodes 13 formed of transparent conductive material are arranged to cover almost whole area, in which pixel dots are arrayed, on the array substrate 1. Thus, the common electrodes 13 cover not only the flat areas 12A, on which the pixel electrode 14 are arranged, but also the rib-shaped protrusions 11. In an illustrated detailed embodiment, the common electrodes 13 are arranged to directly cover the resin film 12. Meanwhile, the pixel electrodes 14 have slits 14B. In the illustrated detailed embodiment, number of the pixel electrodes 14 on each of the pixel dot 3 is one; number of the slits 14B on each of the pixel electrodes 14 is one; and the slit 14B runs almost throughout a length dimension of the pixel electrode 14. Nevertheless, the pixel electrode 14 may be shaped as a single linear electrode having no slit.

A driving voltage applied to the liquid-crystal layer at between the common electrodes 13 on one side and the pixel electrodes 14 on another side induces loop-shaped electric lines 27 of force, each of which runs from the array substrate 1, as shown in FIGS. 1 and 6. As schematically shown in FIG. 1, due to existence of the rib-shaped protrusions 11, curbed is extending of the electric lines 27 of force up to vicinities of the signal lines 15 on right-hand and left-hand sides in FIG. 1.

FIG. 7 is a graph showing, in respect of the display panel 10 of the embodiment of FIG. 1 and of the display panel 10′ of the comparative example of FIG. 6, a relationship between a position and light transmittance (%) of the liquid-crystal layer at a time the driving voltage for white display is applied to the liquid-crystal layer. Here, the position represents a distance (μm) from centerline of the pixel-dot aperture 31 when measured in a manner to run across the pixel-dot aperture 31 in the scanning-line direction as shown in FIG. 1. No significant difference in the light transmittance between the embodiment and the comparative example is observed in a region near the centerline of the pixel-dot aperture 31, which accounts for about 70% of width dimension of the pixel-dot aperture 31 and is other than fringe parts of pixel-dot aperture 31 on its both ends in width direction. On contrary, remarkable difference is observed in the light-shielded areas coinciding the black matrix 24 and its vicinities, which are the right-hand and left-hand side fringe parts of the pixel-dot aperture 31. In particular, the light transmittance at along each centerline of the black matrix 24 or at along the signal lines is almost 0% for the embodiment and is about 5% for the comparative example. Hence, in the embodiment, the color mixing is reliably curbed by low value of the light transmittance in vicinities of the light-shielded areas.

Decrease of the light transmittance in vicinities of the light-shielded areas is presumably because extending of the electrical lines of force is curbed by the rib-shaped protrusions 11 and because the light transmittance is decreased by decreasing of thickness of the liquid-crystal layer by the protrusions 11.

In following, the detailed embodiment illustrated in FIGS. 1-5 is explained more thoroughly.

Firstly, manufacturing of the array substrate 1 may be outlined by following processes 1) through 9) in a sequence. Process 1): on a glass substrate 1A for the array substrate 1, polysilicon wirings 17 are formed and then are covered by a gate insulator film 16B, which may be formed of silicon oxides and/or silicon nitrides. Process 2): by a metal layer such as molybdenum alloy, the scanning lines 16 and branch lines 16A branched out from the scanning lines 16 are formed and then covered by an interlayer insulator film 15B that may be formed of silicon oxides and/or silicon nitrides. Process 3): contact holes 19A are formed to penetrate through the interlayer insulator film 15B and the gate insulator film 16B so as to expose both ends of each of the polysilicon wirings 17. Process 4): on the interlayer insulator film 15B, the signal lines 15 and first island-shaped patterns 15A are formed by metal layer such as a layer of aluminum and/or its alloy. Process 5): the resin film 12, which is transparent and has the rib-shaped protrusions 11, is formed to cover the signal lines 15 and the first island-shaped patterns 15A; and in same time, contact holes 19B are formed to expose a portion of each of the first island-shaped patterns 15A. Process 6): on the resin film 12, there are formed the common electrodes 13, which are formed of transparent conductive material such as ITO (Indium tin oxides) and/or IZO (Indium zinc oxides); and in same time, in the switching-conductance area 32, second island-shaped patterns 13A are formed. Process 7): a common-electrode insulator film 18A is formed to cover up the common electrodes 13; and then, contact holes 19C are formed to expose a portion of each of the second island-shaped patterns 13A. Process 8): there are formed the pixel electrodes 14, which are formed of transparent conductive material such as ITO and/or IZO. Process 9): finally, to form an alignment film 18, a resin layer is formed and then subjected to rubbing procedure or to photo-alignment procedure by irradiation of ultra violet lights.

Procedures for forming the resin film 12 at the process 5) may be as follows. At first, the substrate is coated with light curable resin, which may be mainly formed of acrylate resin and/or epoxy resin. Subsequently, the substrate is subjected to halftone exposure technique, by which UV-light irradiation dose is varied from region to region to achieve predetermined thicknesses in the regions. Subsequently, the substrate is subjected to developing procedure, by which not-cured resin materials are removed, and then to heating procedure, by which the resin film is completely cured. Meanwhile, in the process 7), the common-electrode insulator film 18A may be formed by a resin layer; and may be made in a same manner with the process 5) except that, instead of the halftone exposure technique, an exposure technique using a usual mask is used for forming the contact holes 19C.

Secondly, explanation is made to the switching-conductance area 32 and switching elements. In the illustrated embodiment, each of the polysilicon wirings 17 is L-shaped as in FIG. 4 and has a first linear part, which is overlaid on the signal line 15 and then crosses the scanning line 16, and has a second linear part, which runs into the switching-conductance area 32 in parallel with the scanning line 16 as bent from the first linear part. As shown in FIG. 4 as well as FIGS. 2-3, ends of each of the polysilicon wirings 17 are connected through the contact holes 19A, respectively to a portion of the signal line 15 and to the first island-shaped pattern 15A. The first island-shaped patterns 15A are connected, through the contact holes 19B that penetrate through the resin film 12, to the second island-shaped patterns 13A. The second island-shaped patterns 13A are connected, through the contact holes 19C that penetrate through the common-electrode insulator film 18A, to the pixel electrodes 14.

In the switching-conductance area 32, the branch line 16A branches out from the scanning line 16, in the signal-line direction and crosses the polysilicon wiring 17 as to form here a TFT 17B. In the illustrated detailed embodiment, another TFT 17A is formed at a crossing of the polysilicon wiring 17 and the scanning line 16. Thus, each switching element is formed of a pair of TFTs 17A and 17B.

In a detailed embodiment illustrated in FIG. 2, within the switching-conductance area 32, the island-shaped pattern 15A, which has a relatively large thickness and has been formed simultaneously with the signal lines 15, should be covered by the resin film 12; thus, thickness of the resin film 12 within the switching-conductance area 32 is larger than that within the flat area 12A in the pixel-dot aperture 3. In particular, in the illustrated detailed embodiment, the resin film 12 makes a plateau 11A throughout the switching-conductance area 32. Thus, thickness D3 of the liquid-crystal layer 26 at the switching-conductance area 32 is smaller than thickness D1 at the flat area 12A.

In the detailed embodiment illustrated in FIGS. 2-3 and FIG. 5, the counter substrate 2 has counter protrusions 21 that are formed at a time of film forming process, integrally with the resin film 22 at a time of formation of a resin film 22. In a plan view of FIG. 5, each of the counter protrusions 21 is shaped as a rectangle with rounded angles, which is elongated in the scanning-line direction. As shown in FIGS. 2-3, top parts of the counter protrusions 21 are abutted against top parts of the rib-shaped protrusions 11, which run in the signal-line direction so as to form column spacers or photo spacers. In particular, one of the rib-shaped protrusions 11 running in the signal-line direction is crosswise combined with one of the counter protrusions 21 elongated in the scanning-line direction to form one of the column spacers.

The column spacers formed in this way may be arranged as distributed in a ratio of one to several or more of the pixel dots 3; and, for example, one to four of the pixel dots 3 or one to eight of the pixel dots 3. In the detailed example of FIG. 5, each of the counter protrusions 21 is arranged to a corner of a rectangular shape of the pixel dot 3 that is presented at a non-fringe main part of the FIG. 5.

Manufacturing of the counter substrate 2 may be outlined by following processes i) through iV) in a sequence. Process i): on a glass substrate 2A for the counter substrate 2, the black matrix is formed, which is formed of a resin layer having black pigments as dispersed therein, or of a metal layer. Process ii): three color-filter layers 23R, 23G and 23B are sequentially formed by resin layers respectively having red, green and blue pigments as dispersed therein. Process iii): a resin film 22 is formed as a flattening film to cover up unevenness or difference in thickness among the three color-filter layers 23R, 23G and 23B; and in same time, the counter protrusions 21 are formed at predetermined positions. Process iV): finally, to form an alignment film 25, a resin layer is formed and then subjected to rubbing procedure or to photo-alignment procedure by irradiation of ultra violet lights.

The process iii) for forming the counter protrusions 21 and the resin film 22 on the counter substrate 2 may be made in same manner with the process 6) for forming the rib-shaped protrusions 11 and the resin film 12 on the array substrate 1.

FIG. 8 is a thickness-direction sectional view corresponding to FIG. 1, showing essential part of an LCD panel 10″ according to a modified embodiment of an LCD device. Contour of each of the rib-shaped protrusions 11 in a cross section is trapezoidal or rectangular in the modified embodiment of FIG. 8 while, in the embodiment of FIG. 1, the contour is arc-shaped or smoothly curved. Substantially same extent of curbing of the color mixing is achieved by the modified embodiment of FIG. 8 as in the embodiment of FIG. 1. In particular, even the light transmittance curve as in FIG. 7 is substantially same between the modified embodiment of FIG. 8 and the embodiment of FIG. 1.

In a preferred embodiment, the resin film 1 within the flat area 12A of the array substrate 1 may have a thickness in a range of 0.1 μm to 0.5 μm and more particularly in a range of 0.1 μm to 0.3 μm, and may be omitted as mentioned before.

In a preferred embodiment, a width of each of the rib-shaped protrusions 11 at a half height of their protrusion height D2 may be 0.8 times to 1.3 times, 0.9 times to 1.2 times for example, of a width W2 of respective line part of the black matrix 24; and may be 1.5 times to 4 times, 2 times to 3 times for example, of a width W3 of the signal line 15.

In a preferred embodiment, thickness of the resin film 12 within the plateau 11B as mentioned in conjunction with FIG. 2, may be 1.0 times to 5 times, more preferably 1.5 times to 3 times, of a thickness of metal layer of the signal lines 15 and island-shaped patterns 15A. Difference in thickness of the resin film 12 between the plateau 11A and the flat area 12A, or height difference between the plateau 11A and the flat area 12A, may be in a range of 20% to 80%, in a range of 40% to 50% for example, of the protrusion height D2 of the rib-shaped protrusions 11.

Although the LCD devices in the above-mentioned embodiments and the comparative example is of FFS-mode, curbing of the color mixing is achievable also in the LCD devices of the lateral-field mode other than the FFS-mode. For example, comb-shaped common electrodes may be adoptable in a manner that portions of the common electrodes are partly overlapped with the rib-shaped protrusions. Even when the common electrodes or counter electrodes are arranged in the counter substrates, curbing of the color mixing is achievable because the color-mixing critical angle 28A is increased and because thickness of the liquid-crystal layer is decreased in vicinities of the signal lines.

In the above explanation of manufacturing processes, the rib-shaped protrusions 11 and the resin film 12 within the flat areas 12A are simultaneously formed by the half-tone technique after uniformly coating the substrate with a resin material, but may also be formed by ink-jet technique for example.

In the above explanation, the rib-shaped protrusions are formed only on the array substrate; but some of them, a part of them or all of them may be arranged on the counter substrate 2; and by such a way, a similar effect in some extent would be achievable. In some occasions, the rib-shaped protrusions may be arranged on both of the array and counter substrates 1 and 2 in same regions overlapping the signal lines 15 so that, in these regions, the liquid-crystal layer is sandwiched in a narrow gap between the protrusions 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid-crystal display (LCD) device comprising:
an array substrate, on which signal and scanning lines and pixel electrodes are arrayed and a resin film is provided;
a counter substrate;
a liquid-crystal layer interposed between the array and counter substrates; and
rib-shaped protrusions, which are arranged on the array substrate within a viewing area so as to respectively run along the signal lines and to respectively cover the signal lines, and which are formed by a resin layer of first resin film as integral with the first resin film, and top parts of the rib-shaped protrusions being distanced from inner face of the counter substrate.

2. The LCD device according to claim 1, wherein the rib-shaped protrusions are abutted on counter protrusions arranged on the counter substrate so as to form spacers between the substrates.

3. The LCD device according to claim 1, wherein the counter protrusions are arranged in light-shielded areas within the viewing area and are elongated in a direction along the scanning lines.

4. The LCD device according to claim 1, wherein a ratio of protrusion height of the rib-shaped protrusions covering the signal lines, with respect to thickness of the liquid-crystal layer at regions of the pixel electrodes on flat areas within pixel-dot apertures, is in a range of 15% to 70%.

5. The LCD device according to claim 1, wherein common electrodes are arranged in the array substrate, to be nearer to inner surface of the substrate than the first resin film forming the rib-shaped protrusions.

6. An LCD comprising first and second substrates and a liquid-crystal layer interposed between the substrates;
the first substrate comprising:
first transparent substrate;
signal lines that are arrayed with an interval in a first direction;
scanning lines that are arrayed with an interval in a second direction that intersects the first direction;
switching elements, each of which is electrically connected with one of the scanning lines and with one of the signal lines; and
first resin film that at least covers the switching elements and the signal lines;
the second substrate comprising second transparent substrate and second resin film;
wherein a first gap, which is a distance between the first resin film and the second transparent substrate at regions overlapped with the signal lines, is smaller than a second gap (D1) that is a distance between the first resin film and the second transparent substrate at regions overlapped with the pixel electrodes.

7. The LCD device according to claim 6, further comprising:
common electrodes, by which the first resin film is at least partly covered; and
a third resin film that is arranged at least in regions, in which the common electrodes are overlapped with the pixel electrodes, so as to be interposed between the common electrodes on one hand and the pixel electrodes on another hand.

8. The LCD device according to claim 7, the second substrate further having the second resin film, wherein the liquid-crystal layer is interposed between the first resin film and the second resin film, except for sites, at which spacers for defining gaps between the substrates are formed, if and when such spacers are formed.

9. The LCD device according to claim 8,
wherein each of the switching elements is arranged in vicinity of respective one of the scanning lines and is connected thereto.

10. The LCD device according to claim 9, wherein regions forming the first gap are arranged along the signal lines, at least throughout regions sandwiching the flat area of each of the pixel-dot apertures.

11. The LCD device according to claim 10, wherein an end portion of each of pixel dots, which are elongated in a direction of the signal lines, is provided with a conduction area, through which the switching element and the pixel electrode are electrically connected; in respect of at least some of the pixel dots, the conduction area is sandwiched in a direction along the scanning lines by first and second regions; through the first region, a region forming the first gap runs in a direction of the signal line; and at the second region, a distance between the substrates is larger than the first gap and smaller than the second gap.

12. A manufacturing method of the liquid-crystal display (LCD) device according to claim 11, comprising: forming a resin layer that forms the first gap, simultaneously with the resin film in remaining areas, by applying of light curable resin on the array substrate and subsequent half-tone exposure or by ink-jet technique.
